(19) United States
(12) Patent Application Publication
(10) Pub. No.: US 2015/0168753 A1
(43) Pub. Date: Jun. 18, 2015

(54) LIQUID CRYSTAL DISPLAY PANEL

(71) Applicant: InnoLux Corporation, Miao-Li County (TW)

(72) Inventors: Hungming SHEN, Miao-Li County (TW); Wanling HUANG, Miao-Li County (TW); Kai-neng YANG, Miao-Li County (TW); Tsau-Hua HSIEH, Miao-Li County (TW)

(21) Appl. No.: 14/564,238

(22) Filed: Dec. 9, 2014

(30) Foreign Application Priority Data
Dec. 16, 2013 (TW) 102146373

(51) Int. Cl. G02F 1/1337; G02F 1/1339; G02F 1/1335; G02F 1/1368

(52) U.S. Cl. CPC G02F 1/1337; G02F 1/1368; G02F 1/133784; G02F 1/133788; G02F 1/13394; G02F 1/133514; G02F 1/133723; G02F 2001/136222

(57) ABSTRACT

The present invention relates to a liquid crystal display panel, comprising: a first substrate; a first alignment layer disposing on a surface of the first substrate; a second substrate opposite to the first substrate; a second alignment layer disposing on a surface of the second substrate and opposite to the first alignment layer; and a liquid crystal layer disposing between the first alignment layer and the second alignment layer; wherein, the ratio of a retardation of the first alignment layer to a retardation of the second alignment layer is 0.01-1.

### CROSS REFERENCE TO RELATED APPLICATION

This application claims the benefits of the Taiwan Patent Application Serial Number 102146373, filed on Dec. 16, 2013, the subject matter of which is incorporated herein by reference.

### BACKGROUND OF THE INVENTION

1. Field of the Invention

The present invention relates to a liquid crystal display panel, particularly, to a fringe field switching liquid crystal panel.

2. Description of Related Art

Liquid crystal display panel is characterized by the advantages of light-weighted, slim, and low energy consumption, thus the liquid crystal display panel is applied to various type of display devices. However, the most common disadvantage of the liquid crystal display panel is its narrow viewing angle; the images observed by users may be different due to the different viewing angles. In order to improve the disadvantage of narrow viewing angle, wide viewing angle display panels are developed, and the most widely applied wide viewing angle display panels are vertical alignment liquid crystal display panel (VA) and fringe field switching liquid crystal display panel (FFS).

FFS is one of the convincing techniques for wide viewing angle display panel, and its working principle is: pixel electrodes and common electrodes constitute a fringe electric field, and liquid crystal compounds rotate horizontally to change the transmittance of light. Since the liquid crystal compounds remain horizontally while rotating in the FFS liquid crystal display panel, the FFS panel has a relatively wide viewing angle and the performance of color shift and saturation is quite excellent under a high viewing angle, and mostly applied in portable electrical devices such as tablet PCs and mobile phones.

However, the phenomena of abnormal grayscale, decreased contrast, or scratch might occur when the liquid crystal compounds rotate un-smoothly. Also, due to the low rotation efficiency of the liquid crystal compounds, the afterimage might be prone to occur and thus cause viewer discomfort. Therefore, according to the above issues, the improving method for FFS liquid crystal panel has been continuously proposed.

### SUMMARY OF THE INVENTION

The object of the present invention is to provide a liquid crystal display panel, comprising: a first substrate; a first alignment layer disposed on a surface of the first substrate; a second substrate opposite to the first substrate; a second alignment layer disposed on a surface of the second substrate and opposite to the first alignment layer; and a liquid crystal layer disposed between the first alignment layer and the second alignment layer; wherein, a ratio of a retardation of the first alignment layer to a retardation of the second alignment layer is 0.01-1.

According to a preferred embodiment of the present invention, a ratio of a tilt angle of the first alignment layer to a tilt angle of the second alignment layer is 0.2-1.

According to a preferred embodiment of the present invention, a ratio of a pre-tilt angle of a liquid crystal compound induced by the first alignment layer to a pre-tilt angle of the liquid crystal compound induced by the second alignment layer is 0-1.2.

According to a preferred embodiment of the present invention, the liquid crystal display panel further comprises a spacer, which is disposed on the first substrate or on the second substrate.

According to a preferred embodiment of the present invention, the liquid crystal display panel may be a fringe field switching liquid crystal display panel.

### BRIEF DESCRIPTION OF THE DRAWINGS

FIG. 1-FIG 5 are a schematic views showing the method for preparing a FFS liquid crystal display panel of embodiment 1 of the present invention.

FIG. 6 shows the structure of the FFS liquid crystal display panel of embodiment 2 of the present invention.

FIG. 7 shows the structure of the FFS liquid crystal display panel of embodiment 3 of the present invention.

### DETAILED DESCRIPTION OF THE PREFERRED EMBODIMENT

According to the specific embodiments of the following description, other advantages, and novel features of the invention will be apparent to those skilled in the art. The present invention can also be accomplished by numerous other embodiments. It is to be understood that many other possible modifications and variations can be made without departing from the spirit and scope of the invention as hereinafter claimed.

### Example 1

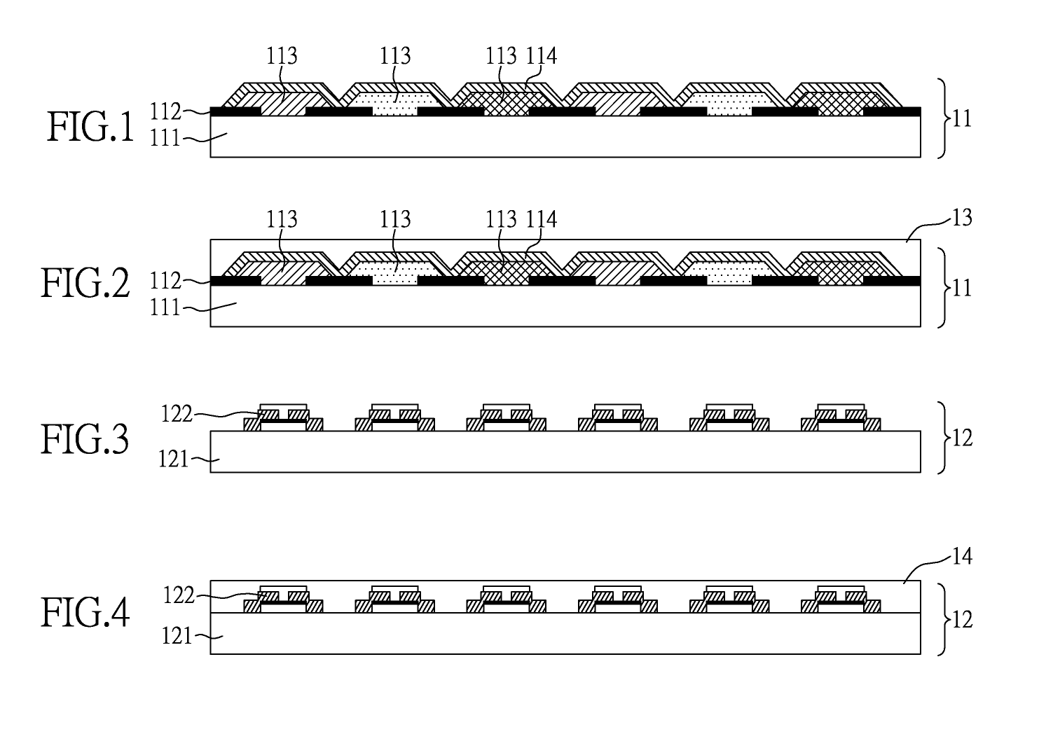

The present example shows a method for preparing a FFS liquid crystal display panel according to a preferred embodiment of the present invention. First, referring to FIG. 1, a first substrate 11 is provided. In the present example, the first substrate 11 is a color filter substrate, which includes an upper substrate 111, black matrix 112, a color layer 113, and an insulating layer 114. However, in other embodiments, the color filter acting as a first substrate 11 can be a color filter known in the art, and the structure of the color filter is not particularly limited. Also, in other embodiments, the first substrate 11 can further comprises spacers disposed thereon. Furthermore, as shown in FIG. 2, a first alignment layer 13 is formed on the first substrate 11 and covers the first substrate 11. In the present example, the first alignment layer 13 is formed by coating a polyimide thin film on first substrate 11 and exposed the polyimide thin film to a light with appropriate illuminating parameters to align the polyimide thin film. For example, the first alignment layer 13 is a photo-alignment layer formed by exposing a polyimide thin film to a linear UV polarized light with 240-365 nm of wave length, 5-80 mW of illuminance, 1-200 seconds of exposure time, and 4-500 mm is of alignment scanning speed. However, the present invention is not particularly limited. In addition, the first alignment layer 13 of the present example is formed by photo-alignment method such as photo-crosslinking method, or photo-dimerization method. In other embodiments, the first alignment layer 13 can be formed by photo-isomerization, photo-crosslinking, photo-dimerization, or photo-degradation methods, wherein photo-crosslinking method and photo-dimerization method are preferred.

Referring now to FIG. 3, a second substrate 12 is provided. In the present example, the second substrate 12 is a thin film transistor substrate which includes a lower substrate 121 and thin film transistor (TFT) 122, and further includes common electrodes and pixel electrodes (not shown) to provide a fringe electric field. The TFT provided by the present invention is a TFT used in FFS liquid crystal display panel. In other embodiments, TFT 122 may be an amorphous silicon TFT, a low temperature poly silicon TFT, a metal oxide TFT, an organic TFT, or other TFTs in the art that may be applied in FFS liquid crystal display panel. Then, as shown in FIG. 4, a second alignment layer 14 is formed on the second substrate 12 and covers the second substrate 12. In the present example, the second alignment layer 12 is formed by rubbing a polyimide thin film disposed on the second substrate 12, and the rolling speed of the rubbing roll may be 800-1600 rpm, the moving speed of the rubbing roll may be 10-100 mm/s, or the rubbing depth may be 0.2-0.55 mm. However, in other embodiments, the rubbing conditions may be altered according to the needed retardation, tilt angle, or pre-tilt angle of the liquid crystal compound for the alignment layers.

As shown in FIG. 5, a FFS liquid crystal display panel is made and accomplished by forming the a liquid crystal layer 15 between first substrate 11 and second substrate 12, wherein the liquid crystal layer 15 is in contact with first alignment layer 13 and second alignment layer 14.

In the present example, the retardation of first alignment layer 13 is 0.54 nm, the retardation of second alignment layer 14 is 0.59 nm, the tilt angle of the first alignment layer 13 is 0.4°, the tilt angle of the second alignment layer 14 is 1°, the pre-tilt angle of the liquid crystal compound induced by the first alignment layer 13 is 0.22°, and the pre-tilt angle of the liquid crystal compound induced by the second alignment layer 14 is 2°.

### Example 2

The preparation method is almost the same as that illustrated in example 1, and was shown in FIGS. 1-5, except that first alignment layer 13 and second alignment layer 14 are prepared by the photo-alignment method. Alignment layer with different alignment properties can be prepared by adjusting the conditions for photo-alignment, wherein the retardation of first alignment layer 13 is 0.5-1.2 nm, the retardation of second alignment layer 14 is 0.4-2.5 nm, the tilt angle of first alignment layer 13 is 0.1-0.5°, the tilt angle of second alignment layer 14 is 0.1-0.5°, the pre-tilt angle of the liquid crystal compound induced by first alignment layer 13 is 0-0.5°, and the pre-tilt angle of the liquid crystal compound induced by second alignment layer 14 is 0-0.5°.

Accordingly, in example 1, the first alignment layer 13 is prepared by photo-alignment method and the second alignment layer 14 is prepared by rubbing method, while in example 2, the first alignment layer 13 and the second alignment layer 14 are both prepared by rubbing method. However, in other embodiments, regardless of the preparation method for the second alignment layer 14, such as rubbing method or photo-alignment layer, the ratio of the retardation of first alignment layer 13 to the retardation of the second alignment layer 14 may be 0.01-1, and is preferred to be 0.01-0.95. The retardation of first alignment layer 13 may be 0.001-1.2 nm, and is preferred to be 0.1-1.2 nm, and is more preferred to be 0.2-1.2 nm, and the retardation of the second alignment layer 14 may be 0.2-3 nm, and is preferred to be 0.4-2.5 nm, and is more preferred to be 0.5-2.5 nm. The ratio of the tilt angle of the first alignment layer 13 to the tilt angle of the second alignment layer may be 0.2-1, and is preferred to be 0.2-0.9, wherein the tilt angle of the first alignment layer 13 may be 0.1-0.5°, and the tilt angle of the second alignment layer 14 may be 0.5-2°. The retardation and tilt angle of the alignment layer can be measured by measuring instruments such as Polarized-ATR-FTIR, Moritex LayScan, Toyo PI-Checker, or Axometrics, but the present invention is not limited thereto. Further, the ratio of the pre-tilt angle of the liquid crystal compound induced by first alignment layer 13 to the pre-tilt angle of the liquid crystal compound induced by second alignment layer 14 may be 0-1.2, wherein the pre-tilt angle of the liquid crystal compound induced by the first alignment layer may be 0-1°, and the pre-tilt angle of the liquid crystal compound induced by the second alignment layer 14 may be 0.5-2.5°. The pre-tilt angle of the liquid crystal compound induced by the alignment layers can be measured by instruments such as Axometrics Gap, but the present invention is not limited thereto.

The FFS liquid crystal display panel of the present invention has a first alignment layer and a second alignment layer with different alignment properties. With the different retardation, tilt angle, and pre-tilt angle of liquid crystal compounds between the first alignment layer and the second layer, the abnormal grayscale and the decreased contrast due to the unsmooth rotation of liquid crystal compounds can be avoided. In addition, abnormal alignment of liquid crystal compounds due to the contamination from the rubbing can be decreased by applying the photo-alignment method instead of the rubbing to prepare the alignment layers.

### Example 3

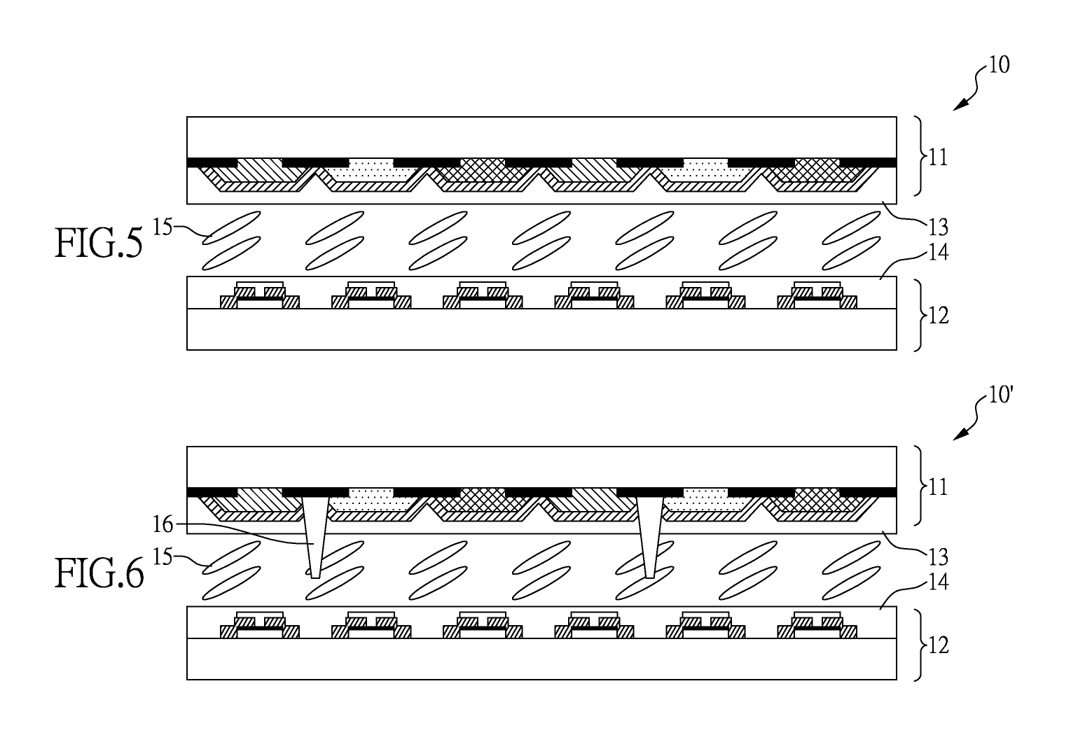

The preparation method is almost the same as that illustrated in example 1 and example 2, except that plurality of spacer 16 is disposed on the first substrate 11. The accomplished FFS liquid crystal display panel 10′ is shown in FIG. 6. In the present example, the properties of first alignment layer 13 and second alignment layer 14, such as retardation, tilt angle, and pre-tilt angle of the liquid crystal compounds are the same as that illustrated as the aforementioned examples.

Further, the pencil hardness of the first alignment layer 13 is 2B-HB, and the pencil hardness of the second alignment layer 14, which corresponds to spacer 16, is H-5H, and the pencil hardness of the second alignment layer 14 is greater than that of the first alignment layer 14. In the present example, the second alignment layer 14 which corresponds to spacer 16 is harder, thus the display failure of the liquid crystal display panel caused by the striped spacer from collision can be avoided. However, in other embodiments of the present invention, spacer 16 may be disposed on the second substrate 12. Accordingly, when spacer 16 is disposed on the second substrate 12, the pencil hardness of first alignment layer is greater than that of the second alignment layer, and the pencil hardness of the first alignment layer 13 may be H-5H, while the pencil hardness of the second alignment layer 14 may be 2B-HB.

Further, when spacer 16 is disposed on the first substrate 11 and the first alignment layer 13 is prepared by rubbing, the unevenness in height due to spacer 16 might easily cause the uneven alignment of the first alignment layer 13, thus effect the display function of the display panel. Therefore, the first alignment layer 13 is preferably prepared by photo-alignment method to ensure the uniformity of the alignment properties. Similarly, when spacer 16 is disposed on the second substrate 12, the first alignment layer 13 and the second alignment layer 14 are preferably prepared by photo-alignment method.

### Example 4

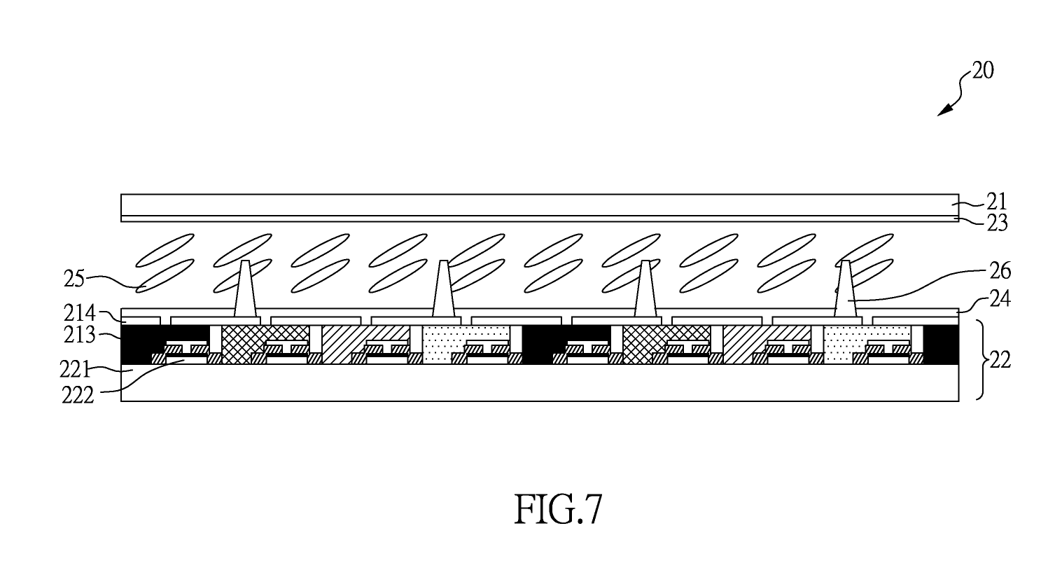

The present example provides an another type of embodiment, the accomplished FFS liquid crystal display panel 20 is shown in FIG. 7, wherein the first substrate 21 is a glass plate; the first alignment layer 23 is formed on one surface of first substrate 21; the second substrate 22 comprises a lower substrate 221, TFTs 222, a color filter substrate 213, and an electrode layer 214; the second alignment layer 24 is formed on one surface of the second substrate 22 and opposite to first alignment layer 23; and spacer 26 is formed on the second substrate 22. The second substrate 22 is a color filter on array substrate that combines a color filter substrate and TFTs, wherein TFT 222 is a TFT used for FFS liquid crystal display panel which further comprises common electrodes and pixel electrodes to provide a fringe electric field.

First alignment layer 23 is prepared by rubbing, and second alignment layer 24 is prepared by photo-alignment method. In other embodiments, first alignment layer 23 and second alignment layer 24 may both be prepared by photo-alignment method. The retardation, tilt angle, and pre-tilt angle of the liquid crystal compound induced by the first alignment layer 23 and the second alignment layer 24 are the same as described in example 3. However, in order to avoid the peeling of the first alignment layer due to the collision between spacer 26 on the second substrate 22 and the first alignment layer 23 on the first substrate 21, the pencil hardness of the first alignment layer 23 is greater than that of the second alignment layer 23, wherein the pencil hardness of the first alignment layer 23 is H-5H and the pencil hardness of the second alignment layer 24 is 2B-HB. However, in other embodiments, spacer 26 may be formed on the first substrate 21 or spacer 26 is not formed. When spacer 26 is formed on the first substrate 21, the pencil hardness of the second alignment layer 24 is greater than that of the first alignment layer 23, wherein the pencil hardness of the second alignment layer 24 may be H-5H and the pencil hardness of the first alignment layer 23 may be 2B-HB.

The embodiments of the present invention are provided for illustrative purposes. It should be noted, however, that the scope and spirit of the invention as disclosed in the accompanying claims, and the scope of the present invention is not limited by the illustrated embodiment.

What is claimed is:

1. A liquid crystal display panel, comprising:
a first substrate;
a first alignment layer disposed on a surface of the first substrate;
a second substrate opposite to the first substrate;
a second alignment layer disposed on a surface of the second substrate and opposite to the first alignment layer; and
a liquid crystal layer disposed between the first alignment layer and the second alignment layer;
wherein, a ratio of a retardation of the first alignment layer to a retardation of the second alignment layer is 0.01-1.

2. The liquid crystal display panel as claimed in claim 1, wherein the ratio of the retardation of the first alignment layer to the retardation of the second alignment layer is 0.01-0.95.

3. The liquid crystal display panel as claimed in claim 1, wherein the retardation of the first alignment layer is 0.001-1.2 nm, and the retardation of the second alignment layer is 0.2-3 nm.

4. The liquid crystal display panel as claimed in claim 1, wherein a ratio of a tilt angle of the first alignment layer to a tilt angle of the second alignment layer is 0.2-1.

5. The liquid crystal display panel as claimed in claim 4, wherein the ratio of the tilt angle of the first alignment layer to the tilt angle of the second alignment layer is 0.2-0.9.

6. The liquid crystal display panel as claimed in claim 4, wherein the tilt angle of the first alignment layer is 0.1° -0.5°; and the tilt angle of the second alignment layer is 0.5°-2°.

7. The liquid crystal display panel as claimed in claim 1, wherein a ratio of a pre-tilt angle of a liquid crystal compound induced by the first alignment layer to a pre-tilt angle of the liquid crystal compound induced by the second alignment layer is 0-1.2.

8. The liquid crystal display panel as claimed in claim 7, wherein the pre-tilt angle of the liquid crystal compound induced by the first alignment layer is 0°-1°; and the pre-tilt angle of the liquid crystal compound induced by the second alignment layer is 0.5°-2.5°.

9. The liquid crystal display panel as claimed in claim 1, wherein at least one of the first alignment layer and the second alignment layer is a photo-alignment layer.

10. The liquid crystal display panel as claimed in claim 1, wherein at least one of the first alignment layer and the second alignment layer is a rubbing alignment layer.

11. The liquid crystal display panel as claimed in claim 1, further comprising a spacer, which is disposed on the first substrate or on the second substrate.

12. The liquid crystal display panel as claimed in claim 11, wherein the spacer is disposed on the first substrate, a pencil hardness of the second alignment layer is greater than a pencil hardness of the first alignment layer.

13. The liquid crystal display panel as claimed in claim 12, wherein the pencil hardness of the first alignment layer is 2B-HB; and the pencil hardness of the second alignment layer is H-5H.

14. The liquid crystal display panel as claimed in claim 11, wherein the first substrate is a color filter substrate, and the second substrate is a thin film transistor substrate.

15. The liquid crystal display panel as claimed in claim 11, wherein the second substrate has a thin film transistor, and a color filter disposed thereon.

16. The liquid crystal display panel as claimed in claim 1, wherein the liquid crystal panel is a fringe field switching liquid crystal panel.
